(19) United States
(12) Patent Application Publication
(10) Pub. No.: US 2012/0286084 A1
(43) Pub. Date: Nov. 15, 2012

(54) BOBBIN FOR LAYER WINDING OF SUPERCONDUCTING WIRE AND LAYER WINDING METHOD USING THE SAME

(76) Inventors: TAE-KUK KO, Seoul (KR); Hyun-Chul Jo, Seoul (KR); Suk-Jin Choi, Seoul (KR); Jin-Bae Na, Seoul (KR); Jae-Young Jang, Incheon (KR); Young-Jin Hwang, Incheon (KR)

(21) Appl. No.: 13/116,343

(22) Filed: May 26, 2011

(30) Foreign Application Priority Data
May 13, 2011 (KR) 10-2011-0045279

(51) Int. Cl. H01F 41/06; H01F 6/06; B65H 54/02; B65H 75/08; B65H 75/14

(52) U.S. Cl. 242/430; 242/613

(57) ABSTRACT

A bobbin for layer winding of superconducting wire and a layer winding method using the same are provided. The bobbin for layer winding of superconducting wire includes a cylindrical bobbin body on which the superconducting wire is wound, and a plurality of spacers having a fan-shaped periphery to guide the superconducting wire, wherein a plurality of layers are formed on the cylindrical bobbin body by the spacers.

### CROSS-REFERENCE TO RELATED APPLICATION

This application claims priority from Korean Patent Application No. 10-2011-0045279 filed on May 13, 2011 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a bobbin for layer winding of superconducting wire and a layer winding method using the same, and more particularly to a bobbin for layer winding of high temperature superconducting wire having a rectangular section and a layer winding method using the same.

2. Description of the Related Art

After discovering superconductivity, many efforts have been made to apply superconductivity technology to the electric power field. Discovery of high temperature superconductivity (HTS) enables a cooling method using liquid nitrogen from a cryogenic cooling method using liquid helium. In fabrication of a coil using superconducting wire, layer winding or pancake winding is used.

FIG. 1 illustrates layer winding of superconducting wire S on a cylindrical bobbin 10. Layer winding is winding wire in a vertical direction, which causes a specific inclination (pitch). Further, after the superconducting wire S is wound on the bobbin 10 through layer winding to form a single layer, the superconducting wire S is wound again thereon and such layer winding is repeated several times.

Layer winding has an advantage of performing winding at once, and also has an advantage in that there is no need for a joint to electrically connect the superconducting wire S to another one. However, layer winding has a problem such that it is required to replace the entire magnet when the magnet is damaged. Further, layer winding is advantageous to wire having a circular section, but is disadvantageous to wire having a rectangular section.

FIG. 2 illustrates layer winding of wire having a circular section. FIG. 3 illustrates layer winding of wire having a rectangular section. In case of wire having a circular section, damage caused by contact is smaller as compared to wire having a rectangular section. Further, wire having a rectangular section is easier to move while the position of the wire is not fixed as compared to wire having a circular section.

FIGS. 4 and 5 illustrate superconducting wire wound by pancake winding. FIG. 4 shows single pancake winding, and FIG. 5 shows double pancake winding. It can be seen that pancake winding is winding the superconducting wire S in a general tape shape. In double pancake winding, two layers of wire are wound in a general tape shape and the wire of one turn at the innermost side is connected from a lower layer to an upper layer. That is, one end of the superconducting wire is pancake wound at the lower layer and the other end of the superconducting wire is pancake wound at the upper layer.

A superconducting magnet is formed by stacking the pancake wound modules. Pancake winding has an advantage in that when the magnet is damaged, only the damaged pancake wound module can be replaced, and is suitable for winding of wire having a rectangular section. However, when stacking the pancake wound modules, there is need for a joint to electrically connect the superconducting wire with another one. Accordingly, there is a problem of generating a contact resistance.

In general, copper wire and metallic low temperature superconducting wire are wound using layer winding because performance is not largely affected by an inclination caused by layer winding.

However, since high temperature superconducting wire is ceramic wire, when it is wound using layer winding, continuous winding in a vertical direction is difficult due to an inclination and it may cause damage to the high temperature superconducting wire. For this reason, the high temperature superconducting wire is generally wound by pancake winding in a horizontal direction. Particularly, since the high temperature superconducting wire is currently fabricated in a shape having a rectangular section, pancake winding is more advantageous.

However, in case of a superconducting coil having a large capacity, pancake winding requires joining of several pancake modules. Accordingly, a contact resistance is generated, and performance of a device is reduced.

Therefore, since layer winding causes no damage to wire because it does not require joining of high temperature superconducting wire and may reduce a contact resistance, there is a demand for applying layer winding to winding of high temperature superconducting wire.

### SUMMARY

The present invention provides a bobbin for layer winding of superconducting wire using pancake winding technology, which causes no damage to high temperature superconducting wire and may reduce a contact resistance, and a layer winding method using the same.

The present invention also provides a bobbin for layer winding of superconducting wire capable of implementing a superconducting coil having a large capacity by layer winding of high temperature superconducting wire using pancake winding technology, and a layer winding method using the same.

The objects of the present invention are not limited thereto, and the other objects of the present invention will be described in or be apparent from the following description of the embodiments.

According to an aspect of the present invention, there is provided a bobbin for layer winding of superconducting wire, including a cylindrical bobbin body on which the superconducting wire is wound, and a plurality of spacers having a fan-shaped periphery to guide the superconducting wire, wherein a plurality of layers are formed on the cylindrical bobbin body by the spacers.

According to another aspect of the present invention, there is provided a method of winding superconducting wire on a bobbin in which a cylindrical bobbin body is divided into layers by a plurality of spacers having a fan-shaped periphery, the method including a first step of winding the superconducting wire by one turn at a start layer of the bobbin body, a second step of winding the superconducting wire on a portion where the spacers are not formed, and then winding the superconducting wire by one turn at a next layer, a third step of winding the superconducting wire by one turn to an end layer of the bobbin body by repeating the first and second steps, and a fourth step of winding the superconducting wire again from the end layer of the bobbin body to the start layer of the bobbin body.

The other aspects of the present invention are included in the detailed description and drawings.

### BRIEF DESCRIPTION OF THE DRAWINGS

The above and other aspects and features of the present invention will become more apparent by describing in detail exemplary embodiments thereof with reference to the attached drawings, in which:

FIG. 1 is shows a conventional layer winding method;

FIG. 2 is a cross-sectional view showing layer winding of wire having a circular section;

FIG. 3 is a cross-sectional view showing layer winding of wire having a rectangular section;

FIG. 4 shows a plan view of wire wound by a conventional pancake winding method;

FIG. 5 shows a perspective view of wire wound by a conventional double pancake winding method;

FIG. 6 shows a perspective view of a bobbin for layer winding of superconducting wire in accordance with an embodiment of the present invention;

FIG. 7 shows a partial perspective view of the bobbin for layer winding of superconducting wire in accordance with the embodiment of the present invention;

FIG. 8 shows a partial plan view of the bobbin for layer winding of superconducting wire in accordance with the embodiment of the present invention;

FIGS. 9 and 10 show a layer winding method of superconducting wire in accordance with the embodiment of the present invention; and

FIGS. 11 to 13 are perspective views showing a winding method of superconducting wire using double pancake winding.

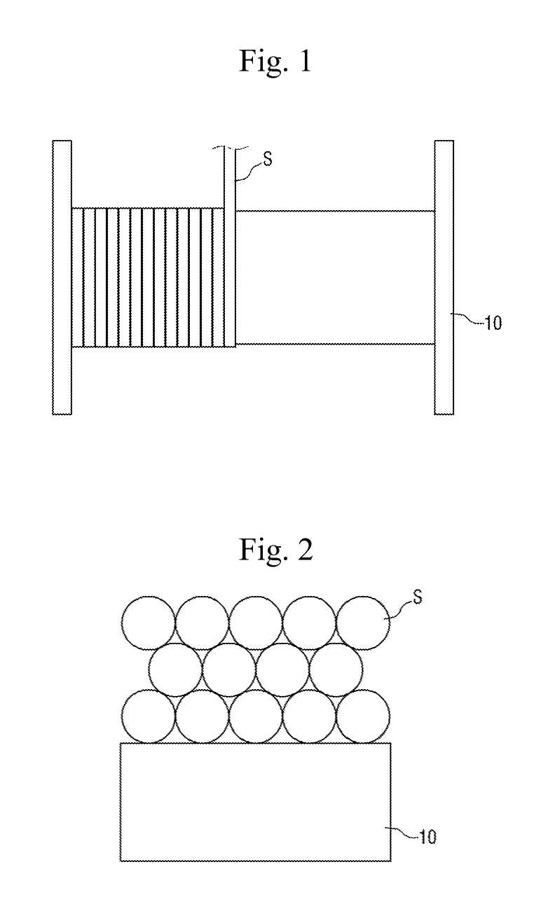

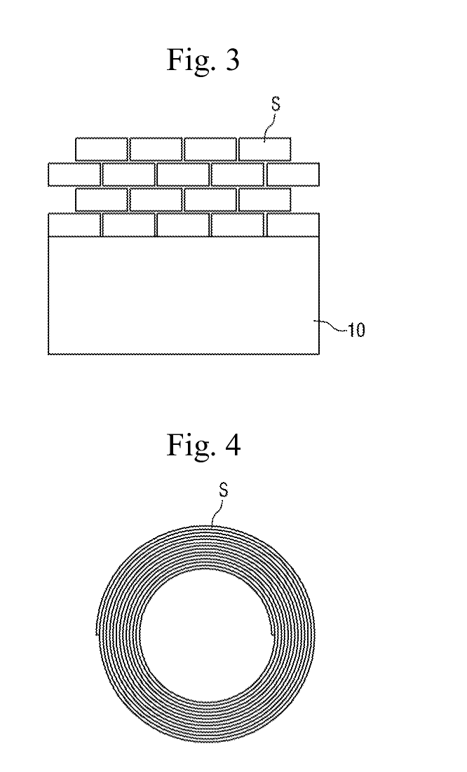

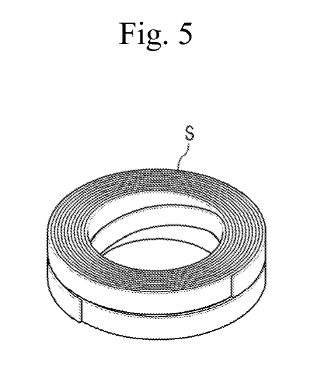

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, embodiments of the present invention will be described in detail with reference to the accompanying drawings which form a part hereof.

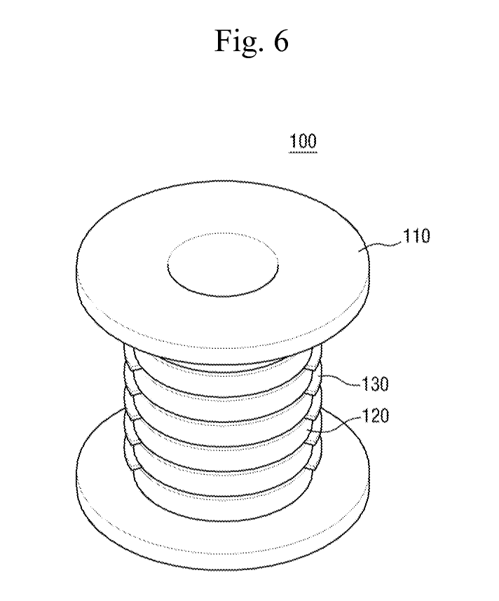

FIG. 6 shows a perspective view of a bobbin for layer winding of superconducting wire in accordance with an embodiment of the present invention.

A bobbin 100 for layer winding of superconducting wire in accordance with the embodiment of the present invention includes a bobbin body 120 and spacers 130. The bobbin 100 for layer winding further includes bobbin barriers 110.

The bobbin body 120, on which superconducting wire S is to be wound, may have a cylindrical shape. Further, the bobbin body 120 may include a hollow portion therein. The bobbin body 120 is formed of a material, which is unaffected by a magnetic field, preferably, glass fiber reinforced plastic (GFRP), Bakelite, insulated aluminum or the like.

The spacers 130 serve to guide the superconducting wire S when it is wound on the bobbin body 120. Each of the spacers 130 has a fan-shaped periphery. The spacers 130 are located at regular intervals on the outer peripheral surface of the bobbin body 120 such that the bobbin body 120 has layers at regular intervals. In other words, a plurality of layers are formed on the cylindrical bobbin body 120 by a plurality of the spacers 130.

The bobbin barriers 110 maintain a shape of the bobbin 100, and support the superconducting wire S wound on the bobbin body 120 at opposite ends of the bobbin 100.

The bobbin body 120 may be divided into a linear portion (where the spacers are formed) in which the superconducting wire S is linearly wound and guided by the spacers 130 when it is wound on the bobbin 100 for layer winding, and a pitch portion (where the spacers are not formed) in which the superconducting wire S is wound at an inclination (pitch).

The superconducting wire S wound on the bobbin 100 generally has a rectangular section. The bobbin body 120 is divided into layers by the spacers 130, and the superconducting wire S having a rectangular section is wound on the outer peripheral surface of the bobbin body 120 by layer winding to which pancake winding is applied. It is preferable that the width of the superconducting wire S is smaller than the width of one of the layers of the bobbin body 120 divided by the spacers 130. When the width of the superconducting wire S is smaller than the width of one of the layers of the bobbin body 120 divided by the spacers 130, it is possible to prevent damage due to the inclination when the superconducting wire S is layer wound. Further, one of Bi—Sr—Ca—Cr—O (BSCCO)-based wire and coated conductor (CC)-based wire may be selectively used as the superconducting wire.

The superconducting wire S is guided by the spacers 130 to be wound in a pancake winding manner in the linear portion of the bobbin body 120 and in a layer winding manner in the pitch portion of the bobbin body 120.

FIG. 6 illustrates the bobbin 100 for layer winding in which the bobbin body 120 has six layers divided by five spacers 130.

The bobbin body 120 includes circular insertion grooves (not shown). The bobbin body 120 and the spacers 130 may be connected to each other by inserting the spacers 130 into the circular insertion grooves. Alternatively, the bobbin body 120 may be formed by combining a plurality of unit bobbin bodies (not shown) corresponding to the respective layers instead of being formed as a single cylindrical body having a hollow portion.

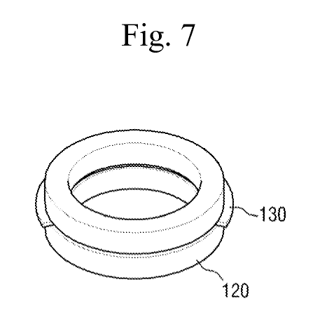

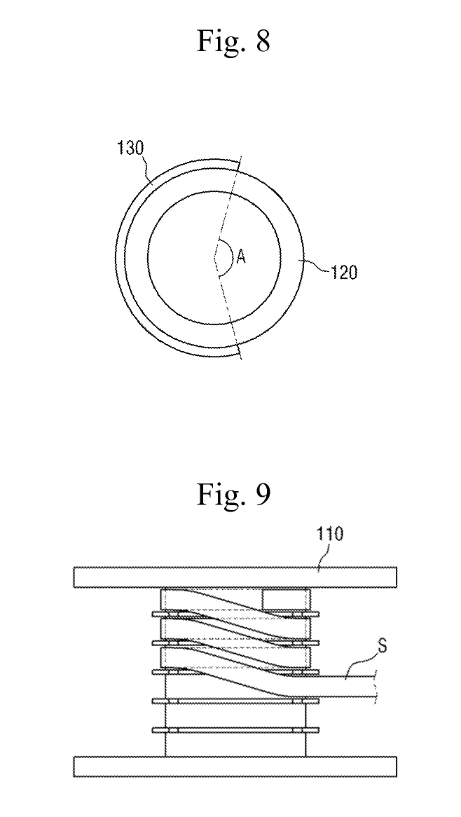

FIGS. 7 and 8 respectively show a partial perspective view and a partial plan view of the bobbin body 120 as a part of the bobbin 100 for layer winding, in which two layers are formed by one spacer 130.

The spacers 130 have a fan-shaped periphery and a predetermined central angle. Preferably, the central angle ranges from 120 to 300 degrees.

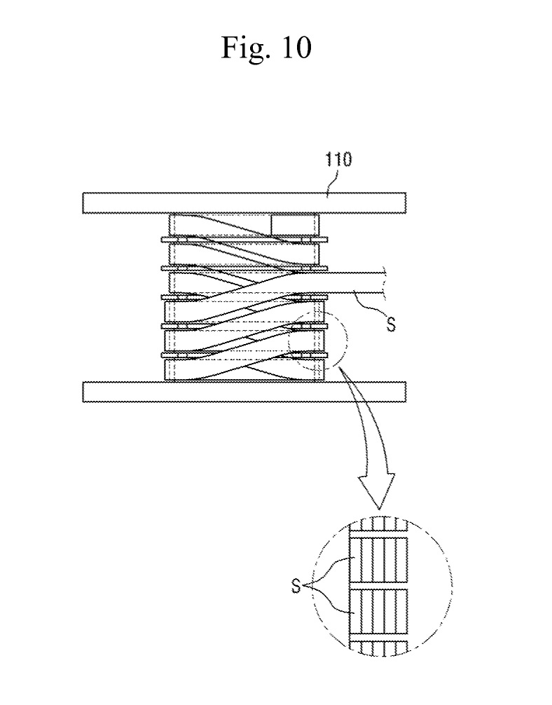

FIGS. 9 and 10 are diagrams showing a layer winding method of superconducting wire in accordance with the embodiment of the present invention.

FIGS. 9 and 10 illustrate a bobbin for layer winding of the superconducting wire S in which six layers are formed on the bobbin body 120 by five spacers 130.

When the superconducting wire S is wound on the bobbin 100 in which the cylindrical bobbin body 120 is divided into layers by the fan-shaped spacers 130, the superconducting wire S is wound by one turn at a start layer of the bobbin body 120. Although the uppermost layer serves as the start layer in FIGS. 9 and 10, the lowermost layer or an intermediate layer may become the start layer. Since the superconducting wire S is wound linearly at the start layer without an inclination, it may have the same effect as in the pancake winding.

Then, the superconducting wire S is wound on the portion where the spacers 130 are not formed, and the superconducting wire S is wound by one turn at the next layer. In this case, the superconducting wire S is naturally wound at the next layer with an inclination as in the layer winding.

Thereafter, the superconducting wire S is repeatedly wound by one turn in order until it reaches an end layer of the bobbin body 120. The superconducting wire S is wound linearly at each layer of the bobbin body 120, and the superconducting wire S is layer wound when the superconducting wire S moves to the next layer.

Then, the superconducting wire S is wound again from the end layer of the bobbin body 120 to the start layer of the bobbin body 120. In the same manner, the superconducting wire S is wound linearly at each layer of the bobbin body 120, and the superconducting wire S is wound with an inclination when the superconducting wire S moves to the next layer.

Further, the winding direction when the superconducting wire S is wound on the portion where the spacers 130 are not formed from the end layer to the start layer is opposite to that when the superconducting wire S is wound on the portion where the spacers 130 are not formed from the start layer to the end layer. Consequently, the superconducting wire S is wound to be overlapped in an X shape. That is, as shown in FIG. 10, when the superconducting wire is wound on the portion where the spacers 130 are not formed in the primary winding and the secondary winding, the superconducting wire is wound in opposite directions to each other.

Further, when the superconducting wire S is wound on the portion where the spacers 130 are not formed, it is preferable that the superconducting wire S is wound at an inclination ranging from 1 to 10 degrees.

The superconducting wire may be wound on the bobbin 100 by several turns according to the capacity of the superconducting coil. That is, supposing that the superconducting wire is wound by one turn when it is wound from the start layer to the end layer of the bobbin body 120 and then wound from the end layer to the start layer of the bobbin body 120, the superconducting wire S may be wound by n turns according to the required capacity of the superconducting coil, wherein n is a natural number.

Further, as shown in a partial enlarged view of FIG. 10, since the linear portion and the pitch portion of the bobbin body 120 are subjected to winding alternately and sequentially, in case of layer winding the wire having a rectangular section, it is possible to efficiently fix the position of the wire.

In this case, the larger the capacity of the superconducting coil, the larger the winding thickness of the superconducting wire. Accordingly, it is preferable to flexibly apply the thickness of the spacers 130 according to the capacity of the superconducting coil. Further, it is preferable that the fan-shaped spacers 130 have a central angle ranging from 120 to 300 degrees. Particularly, it is preferable that a central angle A of the portion of the bobbin body 120 where the spacers 130 are not formed is about 150 degrees, and a central angle of the spacers 130 is about 210 degrees.

When the superconducting wire S having a rectangular section is wound on the bobbin body 120, the superconducting wire S guided by the spacers 130 is wound without an inclination (effect of pancake winding), and the superconducting wire S wound on the portion where the spacers 130 are not formed is wound with an inclination (pitch) (effect of layer winding).

Therefore, there is no need for a joint material to electrically connect pancake coils because high temperature superconducting wire S having a rectangular section is not pancake wound. Accordingly, a contact resistance is not generated. Further, it is easy to wind the superconducting wire S having a rectangular section because the superconducting wire S is guided by the spacers 130. Furthermore, since the superconducting wire S is wound with an inclination only on the portion where the spacers 130 are not formed, it is possible to prevent damage of the superconducting wire S and to wind the superconducting wire S at once.

In this case, the superconducting wire S may have a rectangular section, and the width of the superconducting wire S is preferably smaller than the width of the layers of the bobbin body 120 divided by the spacers 130. Further, the superconducting wire may be formed by selectively using one of Bi—Sr—Ca—Cr—O (BSCCO)-based wire and coated conductor (CC)-based wire.

Hereinafter, characteristics of a double pancake winding method and a layer winding method of superconducting wire in accordance with the embodiment of the present invention will be discussed based on experimental results.

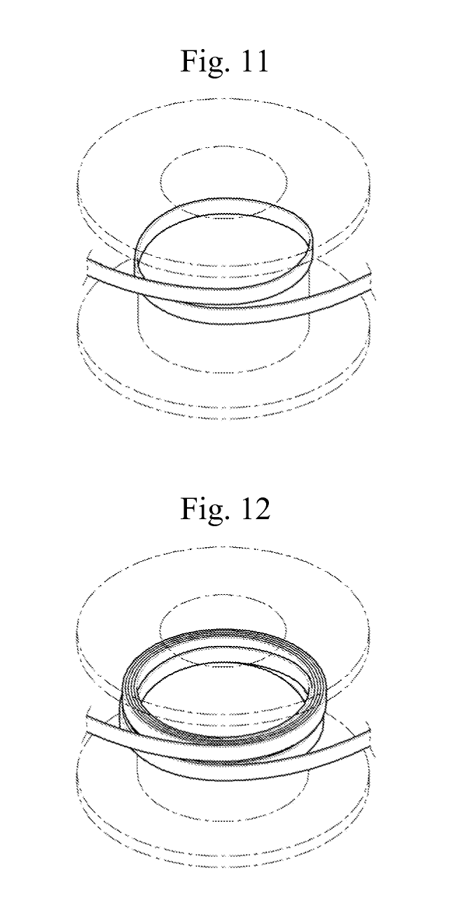

FIGS. 11 to 13 are perspective views showing a winding method of the superconducting wire S using double pancake winding.

One half portion of the superconducting wire S in its lengthwise direction is pancake wound on an upper part by one turn, and the other half portion of the superconducting wire S in its lengthwise direction is pancake wound on a lower part by one turn. Then, the superconducting wire S is pancake wound on the upper part and the lower part, respectively, by several turns. After stacking double pancake wound modules, the double pancake wound modules are connected to each other by using a superconducting wire piece.

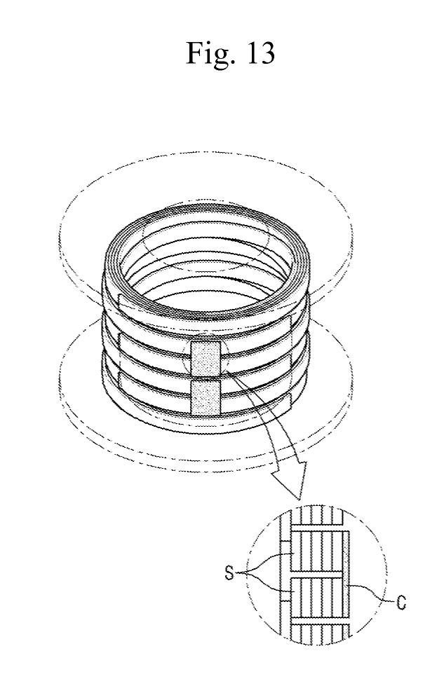

The superconducting wire S of one turn at the innermost side in FIG. 11 supports double pancake winding turns. Accordingly, as shown in a partial enlarged view of FIG. 13, in winding of a double pancake module, the upper and lower parts are connected to each other by only the superconducting wire S at the innermost side, and connection between the double pancake modules is performed by applying melted solder paste such as indium (In) and lead (Pb) to the superconducting wire at the outermost side. On the contrary, in layer winding in accordance with the embodiment of the present invention, as shown in a partial enlarged view of FIG. 10, upper and lower layers of the superconducting wire S are connected to each other directly (one to one) to thereby support the superconducting wire S as in laying bricks. Therefore, although the wire having a rectangular section is layer wound, it is possible to efficiently fix the position of the wire.

For the same experimental conditions, a bobbin for layer winding in accordance with the embodiment of the present invention wherein the superconducting wire S is wound by five turns on the bobbin 100 for layer winding shown in FIG. 10 and a bobbin for double pancake winding wherein three double pancake modules having the superconducting wire S wound by five turns as shown in FIG. 13 are connected to each other by using indium solder, i.e., two types of sample bobbins, are prepared.

The physical characteristics of the two sample bobbins are presented in Table 1 below.

TABLE 1

| | Bobbin for pancake | |
|---|---|---|
| | winding | Bobbin for layer winding |
| Inner diameter | 60 mm | |
| Outer diameter | Varied according to types of superconducting wire | |
| Height | 37 mm | |
| Wire length | 5.94 mm | 5.88 mm |
| Joint | 2 | No |

The superconducting wires S of the two bobbins have the same width and length, and three samples of the superconducting wire S are used. The samples of the superconducting wire S are prepared by using one type of Bi—Sr—Ca—Cr—O (BSCCO)-based wire, and two types of coated conductor (CC)-based wire. The two types of coated conductor (CC)-based wire used in the samples include coated conductor (CC)-based wire having a stabilizer and coated conductor (CC)-based wire having no stabilizer.

The physical characteristics of the three types of the superconducting wire S are presented in Table 2 below.

TABLE 2

| | Type 1 | Type 2 | Type 3 |
|---|---|---|---|
| Manufacturer | American | Seo-nam | SuperPower |
| | Superconductor | | |
| Conductor | BSCCO | CC | CC |
| Width | 4 mm | 4 mm | 4 mm |
| Thickness | 0.26 mm | 0.1 mm | 0.055 mm |
| Stabilizer | Stainless steel | Copper | — |
| Substrate | — | Hastelloy | Hastelloy |
| Critical Current | 125 A | 112 A | 111 A |
| at 77K | | | |

The experiment was conducted on six samples in which three types of superconducting wire (Type 1, Type 2, Type 3) are wound on two types of sample bobbins (bobbin for pancake winding and bobbin for layer winding).

Critical currents of the six samples at a temperature of 77K are presented in Table 3 below.

TABLE 3

| | Critical current | Critical current | Critical current |
|---|---|---|---|
| | of Type 1 | of Type 2 | of Type 3 |
| Pancake bobbin | 81 A | 98 A | 84 A |
| Layer bobbin | 81 A | 103 A | 81 A |

It can be seen from the results of Table 3 that there is almost no difference between critical currents of the sample bobbins according to a winding method of the superconducting wire S based on the measurement results of critical currents. In case of BSCCO wire, there is no difference according to a winding method. In case of CC wire having a stabilizer and CC wire having no stabilizer, there are differences in critical current of about 5 A and 3 A, respectively.

Comparisons with critical currents of the superconducting wire S when it is not wound on the bobbins are presented in Table 4 below.

TABLE 4

| | Type 1 | Type 2 | Type 3 |
|---|---|---|---|
| Pancake | 0.65 (81 A/125 A) | 0.88 (98 A/112 A) | 0.76 (84 A/111 A) |
| bobbin | | | |
| Layer | 0.65 (81 A/125 A) | 0.92 (103 A/112 A) | 0.73 (81 A/111 A) |
| bobbin | | | |

From the results of Tables 3 and 4, it can be seen that critical currents of superconducting wire of the respective sample bobbins are not largely affected by a winding method. Further, it can be seen that the critical current of CC wire having a stabilizer decreases by the smallest value compared to wire of a single material.

Consequently, because the superconducting wire layer wound on the bobbin 100 for layer winding and the pancake wound superconducting wire have similar critical currents, it can be seen that the high temperature superconducting wire S having a rectangular section can be layer wound.

Therefore, it is possible to implement a high temperature superconducting coil without a contact resistance by winding the high temperature superconducting wire S using layer winding instead of pancake winding.

According to the present invention, high temperature superconducting wire can be wound without a joint by layer winding of superconducting wire using pancake winding technology. Thus, it is possible to prevent damage of wire and reduce a contact resistance of a superconducting coil.

Further, it is possible to implement a superconducting coil having a large capacity by layer winding of superconducting wire using pancake winding technology.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A bobbin for layer winding of superconducting wire, comprising:
a cylindrical bobbin body on which the superconducting wire is wound; and
a plurality of spacers having a fan-shaped periphery to guide the superconducting wire,
wherein a plurality of layers are formed on the cylindrical bobbin body by the spacers.

2. The bobbin of claim 1, wherein the superconducting wire has a rectangular section.

3. The bobbin of claim 2, wherein a width of the superconducting wire is smaller than a width of one of the layers of the bobbin body divided by the spacers.

4. The bobbin of claim 1, wherein a central angle of the spacers having a fan shape ranges from 120 to 300 degrees.

5. The bobbin of claim 1, wherein the bobbin body includes circular insertion grooves.

6. The bobbin of claim 5, wherein the bobbin body and the spacers are connected to each other by inserting the spacers into the insertion grooves.

7. A method of winding superconducting wire on a bobbin in which a cylindrical bobbin body is divided into layers by a plurality of spacers having a fan-shaped periphery, the method comprising:
a first step of winding the superconducting wire by one turn at a start layer of the bobbin body;
a second step of winding the superconducting wire on a portion where the spacers are not formed, and then winding the superconducting wire by one turn at a next layer;
a third step of winding the superconducting wire by one turn to an end layer of the bobbin body by repeating the first and second steps; and
a fourth step of winding the superconducting wire again from the end layer of the bobbin body to the start layer of the bobbin body.

8. The method of claim 7, wherein one of Bi—Sr—Ca—Cr—O (BSCCO)-based wire and coated conductor (CC)-based wire is selectively used as the superconducting wire.

9. The method of claim 7, wherein the superconducting wire has a rectangular section.

10. The method of claim 9, wherein a width of the superconducting wire is smaller than a width of one of the layers of the bobbin body divided by the spacers.

11. The method of claim 7, wherein a central angle of the spacers having a fan shape ranges from 120 to 300 degrees.

12. The method of claim 7, wherein when the superconducting wire is wound on the portion where the spacers are not formed in the second and fourth steps, the superconducting wire is wound at an inclination ranging from 1 to 10 degrees.

13. The method of claim 7, wherein when the superconducting wire is wound on the portion where the spacers are not formed in the second and fourth steps, the superconducting wire is wound in opposite directions to each other.

14. The method of claim 7, further comprising a fifth step of winding the superconducting wire by n turns by repeating the first to fourth steps.
